(19) United States
(12) Patent Application Publication
(10) Pub. No.: US 2011/0052950 A1
(43) Pub. Date: Mar. 3, 2011

(54) SECONDARY BATTERY

(75) Inventor: Hojoon Yoo, Suwon-si (KR)

(73) Assignee: Samsung SDI Co., Ltd., Suwon-si (KR)

(21) Appl. No.: 12/837,715

(22) Filed: Jul. 16, 2010

(30) Foreign Application Priority Data
Sep. 1, 2009 (KR) 10-2009-0082158

(51) Int. Cl. H01M 10/48

(52) U.S. Cl. 429/90

(57) ABSTRACT

A secondary battery includes an indication member that clearly indicates from the outside of the battery whether gas is released and can prevent external moisture and foreign materials from being introduced into the battery through a gas release hole. The secondary battery includes an electrode assembly, a can in which the electrode assembly is disposed, a cap disposed at an upper portion of the can and having at least one gas release hole, and an indication member adhered to an interior side of the cap that indicates whether a pressure within the secondary battery is sufficient to disable the secondary battery.

### CROSS-REFERENCE TO RELATED APPLICATION

This application claims the benefit of Korean Patent Application No. 10-2009-0082158, filed Sep. 1, 2009, in the Korean Intellectual Property Office, the disclosure of which is incorporated herein by reference.

### BACKGROUND OF THE INVENTION

1. Field of the Invention

Aspects of the present invention relate to a secondary battery which indicates from the outside of the battery whether a gas has been released.

2. Description of the Related Art

A secondary battery may increase in internal temperature due to an abnormal state of use, such as short-circuiting or over-charging, or an increase in the internal pressure due to gas generation.

When a nickel-hydrogen battery is overcharged, for example, a hydroxyl group (OH—) in an electrolyte may decompose to generate oxygen gases, thereby increasing the internal pressure of the battery. When a lithium secondary battery using metallic lithium or carbon as a negative active material is over-discharged, heat may be generated, which facilitates decomposition of an organic electrolyte and generation of gases resulting in an abrupt increase in the internal pressure of the battery.

As described above, when the internal pressure of the battery rises, the electrolyte may become exhausted due to swelling of electrode plates in the secondary battery. In addition, the electrolyte may leak into surrounding areas of a cap assembly, which decreases the performance and life characteristics of the battery.

### SUMMARY OF THE INVENTION

An aspect of the present invention provides a secondary battery which clearly indicates from the outside of the battery whether gas is released.

Another aspect of the present invention provides a secondary battery which can prevent external moisture and/or foreign materials from being introduced into the battery through a gas release hole.

In accordance with an embodiment of the present invention, there is provided a secondary battery including an electrode assembly, a can in which the electrode assembly is disposed, a cap disposed at an upper portion of the can and having at least one gas release hole, and an indication member adhered to an interior side of the cap that indicates whether a pressure within the secondary battery is sufficient to disable the secondary battery.

According to aspects of the invention, the indication member may be formed as a film that closes the at least one gas release hole. According to aspects of the invention, the indication member may have a fracture recess formed in a surface thereof facing the at least one gas release hole. According to aspects of the invention, the indication member may have a fracture recess formed in a surface thereof facing away from the at least one gas release hole. According to aspects of the invention, the indication member may have fracture recesses formed both in a surface thereof facing and in a surface thereof facing away from the at least one gas release hole, respectively.

According to aspects of the invention, the indication member may include a first film that closes the at least one gas release hole and adhered to the interior side of the cap, a second film adhered to the first film, and a dye filling a space between the first and second films. According to aspects of the invention, the dye may have a color different from a color of the first film.

According to aspects of the invention, the secondary battery may further include an auxiliary plate disposed between the cap and the indication member. According to aspects of the invention, the auxiliary plate may be shaped as a funnel having a lower end circumference larger than an upper end circumference and is coupled to the cap, wherein the upper end circumference is disposed away from the can. According to aspects of the invention, the auxiliary plate may have at least one hole formed therethrough at a position corresponding to the at least one gas release hole formed in the cap so as to communicate with each other. According to aspects of the invention, the auxiliary plate may be coupled to the interior side of the cap by thermal fusion, welding, or forced fitting.

According to aspects of the invention, the indication member may be fractured when the gas is released through the gas release hole. According to aspects of the invention, the indication member may protrude outside the gas release hole when the pressure within the can is sufficient to disable the secondary battery.

According to aspects of the invention, the secondary battery may further include a safety vent formed at a lower portion of the cap to interrupt a current and release the gas when an abnormal internal pressure occurs inside the can. In this case, the indication member may be fractured when the gas is released through the gas release hole.

According to aspects of the invention, the indication member may be made of a metal or polymer. According to aspects of the invention, the indication member may be adhered to the interior side of the cap by thermal fusion or welding.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a cross-sectional view illustrating a structure of a secondary battery according to an exemplary embodiment of the present invention;

FIGS. 2A through 2H are cross-sectional views illustrating an embodiment of an indication member shown in FIG. 1;

FIG. 3 is a sectional views illustrating another embodiment of an indication member;

FIG. 4 is a sectional views illustrating still another embodiment of an indication member;

FIGS. 5A and 5B are sectional views illustrating another embodiment of an indication member; and

FIGS. 6A and 6B are sectional views illustrating still another embodiment of an indication member.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

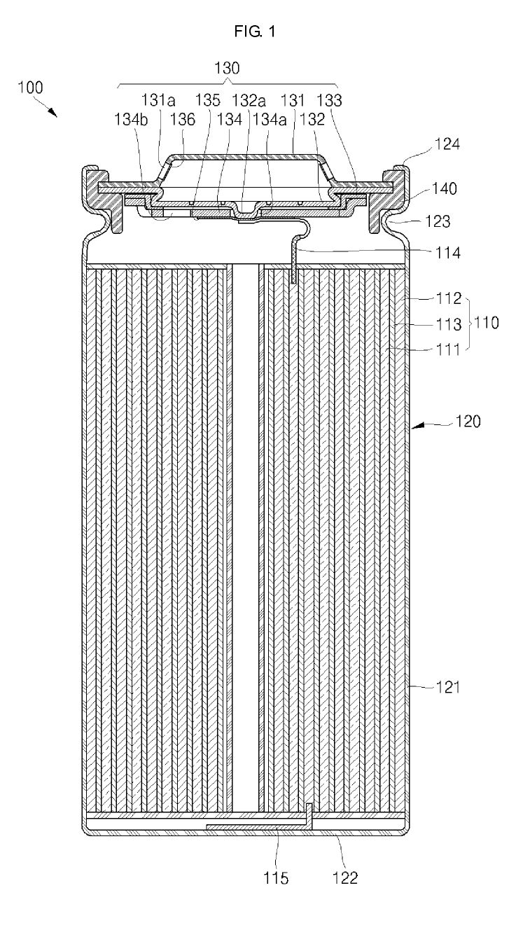

FIG. 1 is a cross-sectional view illustrating a structure of a secondary battery according to an exemplary embodiment of the present invention. As shown in FIG. 1, the secondary battery 100 includes an electrode assembly 110, a can 120 in which the electrode assembly 110 is disposed, a cap assembly 130 coupled to an upper end opening of the can 120, and a gasket 140 tightly sealing the can 120 and the cap assembly 130.

The electrode assembly 110 includes a positive electrode plate 111 having a positive electrode coating portion coated on a positive electrode collector, a negative electrode plate 112 having a negative electrode coating portion coated on a negative electrode collector, and a separator 113 disposed between the positive electrode plate 111 and the negative electrode plate 112 to electrically insulate the positive electrode plate 111 and the negative electrode plate 112 from each other. A positive electrode tab 114 is provided at an upper portion of the electrode assembly 110 and is connected to the cap assembly 130. A negative electrode tab 115 is provided at an upper portion of the electrode assembly 110 and is connected to a bottom surface of the can 120.

The positive electrode collector of the positive electrode plate 111 is made of a conductive metal so as to collect electrons from the positive electrode coating portion and to move the collected electrons to an external circuit. The positive electrode coating portion is prepared by mixing a positive electrode active material, a conductive member, and a binder, and coating the resultant mixture on the positive electrode collector at a predetermined thickness. In the positive electrode collector, a positive electrode non-coating portion is formed at either end portion of the positive electrode plate 111, where the positive electrode coating portion is not formed, and the positive electrode tab 114 is welded to the positive electrode plate 111 at the positive electrode non-coating portion.

The negative electrode collector of the negative electrode plate 112 is made of a conductive metal so as to collect electrons from the external circuit via the negative electrode coating portion. The negative electrode coating portion is prepared by mixing a negative electrode active material, a conductive member, and a binder, and coating the resultant mixture on the negative electrode collector at a predetermined thickness. In the negative electrode collector, a negative electrode non-coating portion is formed at either end portion of the negative electrode plate 112, where the negative electrode coating portion is not formed, and the negative electrode tab 115 is welded to the negative electrode plate 112 at the negative electrode non-coating portion.

The separator 113 is disposed between the positive electrode plate 111 and the negative electrode plate 112 and may extend to surround an outer circumferential surface of the electrode assembly 110. The separator 113 is formed of a porous film made of a polymeric material capable of preventing short-circuit between the positive electrode plate 111 and the negative electrode plate 112 and allows lithium ions to pass therethrough.

The can 120 includes a cylindrical body 121 having a predetermined diameter to provide a space to accommodate the electrode assembly 110, and a bottom plate 122 to seal the bottom of the cylindrical body 121. An upper end of the can 120 is opened to allow the electrode assembly 110 to be inserted into the can 120. The upper end of the can 120 is sealed after the electrode assembly 110 is inserted into the can 120. A beading part 123 prevents movement of the electrode assembly 110 and is provided at an upper portion of the can 120. A crimping part 124 secures the cap assembly 130, and the gasket 140 is disposed at the uppermost end of the can 120 between the cap assembly 130 and the beading and crimping parts 123 and 124.

The cap assembly 130 includes a cap 131, a safety vent 132 disposed at a lower portion of the cap 131, a cap plate 134 disposed at a lower portion of the safety vent 132, an insulator 133 disposed between the safety vent 132 and the cap plate 134, a current interrupting portion 135 disposed on a bottom surface of the cap plate 134 and electrically connected to the positive electrode tab 114, and an indication member 136 disposed at an interior side of the cap 131.

The cap 131 has a convex portion that extends away from the can and is electrically connected to an external circuit. The cap 131 is electrically connected to the electrode assembly 110 to transfer a current generated from the electrode assembly 110 to the external circuit. The cap 131 includes a gas release hole 131a, which provides a gas release path through which the gas generated inside the can 120 can be released.

The safety vent 132 is formed in a shape of a circular plate conformable to the cap 131 and includes a protrusion 132a that protrudes downward, i.e., toward the electrode assembly 110 disposed in the can 120. The protrusion 132a is formed at the center of the safety vent 132. The safety vent 132 is disposed at a bottom portion of the cap 131 between the insulator 133 and the cap 131. The safety vent 132 includes a protrusion 132a to electrically connect the safety vent 132 to the current interrupting portion 135, which is fixed to the bottom surface of the cap plate 134, through a throughhole 134a in the cap plate 134.

The safety vent 132, which contacts areas of the cap 131 other than the upward convex portion thereof, allows the internal gas to be released while interrupting the current when the internal pressure abnormally increases. However, aspects are not limited thereto, such that the safety vent 132 need not contact all areas of the cap 131 other than the upward convex portion thereof. When the internal pressure of the can 120 exceeds the operating pressure of the safety vent 132, the protrusion 132a of the safety vent 132 is elevated by gas released through a gas release hole 134b of the cap plate 134, so that the safety vent 132 is electrically disconnected from the current interrupting portion 135. In addition, when the internal pressure of the can 120 exceeds a fracture pressure of the safety vent 132, which is set to be higher than the operating pressure of the safety vent 132, the safety vent 132 is fractured so that the safety vent 132 is electrically disconnected from the current interrupting portion 135.

The insulator 133 is disposed between the safety vent 132 and the cap plate 134 and insulates the safety vent 132 and the cap plate 134 from each other.

The cap plate 134 is formed in a shape of a circular plate. The throughhole 134a is formed at the center of the cap plate 134 to allow the protrusion 132a of the safety vent 132 to penetrate therethrough. The gas release hole 134b, through which gas is released, is formed at one side of the cap plate 134. When the internal pressure of the can 120 abnormally increases, the protrusion 132a of the safety vent 132 is raised by the released gases.

The current interrupting portion 135 is welded between the protrusion 132a of the safety vent 132, which penetrates through the throughhole 134a, and the positive electrode tab 114. However, aspects are not limited thereto such that the current interrupting portion 135 may be welded to only one of the protrusion 132a and the positive electrode tab 114 or may be held in place against the cap plate 134 by the positive electrode tab 114 with no weld. Accordingly, the current interrupting portion 135 electrically connects the positive electrode tab 114 to the safety vent 132. If the internal pressure of the can 120 increases, the protrusion 132a of the safety vent 132 is elevated away from the current interrupting portion 135 so that the current interrupting portion 135 is electrically disconnected from the safety vent 132. Here, the current interrupting portion 135 may be welded to the protrusion 132a of the safety vent 132 and/or the positive electrode tab 114 by laser welding, resistance welding, or the like.

The indication member 136 is adhered to an interior side of the cap 131 and closes or covers the gas release hole 131a. The indication member 136 is fractured or protrudes outside the gas release hole 131a when the gas released through gas release hole 134b of the cap plate 134 is exhausted to the gas release hole 131a of the cap 131. In addition, when the safety vent 132 is fractured due to an abnormal increase in the internal pressure of the can 130, the indication member 136 may be fractured or protrude outside the gas release hole 131a. Aspects of the invention are not limited thereto such that the safety vent 132 need not be fractured for the indication member 136 to indicate that gas has been released in the secondary battery 100; instead, the safety vent 132 may merely become electrically disconnected from the current interruption portion 135 such that the indication member 136 clearly indicates that the secondary battery 100 has been even temporarily disabled.

The indication member 136 may be made of metal or polymer. In addition, the indication member 136 may be bonded to the cap by thermal fusion or welding. As described above, since the indication member 136 is fractured or protrudes outside the gas release hole 131a, the gas release can be easily identified. Further, since the indication member 136 closes the gas release hole 136a, it is possible to prevent moisture or foreign materials from being introduced to the secondary battery 100 through the release hole 131a.

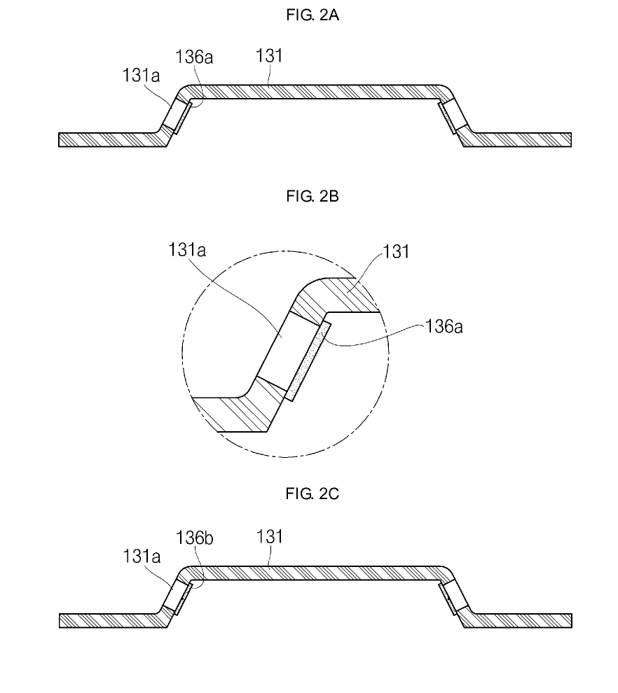

The indication member 136 may have various shapes, which will be described in more detail with reference to FIGS. 2A through 6A. FIGS. 2A through 2H are cross-sectional views illustrating an embodiment of an indication member shown in FIG. 1.

Referring to FIGS. 2A and 2B, an indication member 136a is formed in a film type or having a planar shape such that the indication member 136a closes the gas release hole 131a, and the indication member 136a may be incorporated into or disposed on the inner surface of the cap 131. As shown in FIGS. 2C and 2D, an indication member 136b may have a fracture recess formed on a surface of the indication member 136b facing the gas release hole 131a, i.e., an outer surface of the indication member 136b. As shown in FIGS. 2E and 2F, an indication member 136c may have a fracture recess formed on a surface of the indication member 136c facing away from the gas release hole 131a, i.e., an inner surface of the indication member 136c. As shown in FIGS. 2G and 2H, an indication member 136d may have fracture recesses formed on both of the inner and outer surfaces of the indication member 136d, respectively. As described above, the indication member 136 may be formed in a film type in which the indication member 136b closes the gas release hole 131a. Alternatively, the indication member 136 may be adhered to an exterior side of the cap 131.

The indication member 136 closes the gas release hole 131a at normal times, while it is fractured through the gas release hole 131a when the gas is released. In such a manner, the gas release can be easily identified from the outside of the battery.

In addition, when the gas is released through the gas release hole 131a, the indication member 136 is fractured along the fracture recesses formed on the inner surface and/or the outer surface of the gas release hole 131a, thereby clearly indicating the gas release.

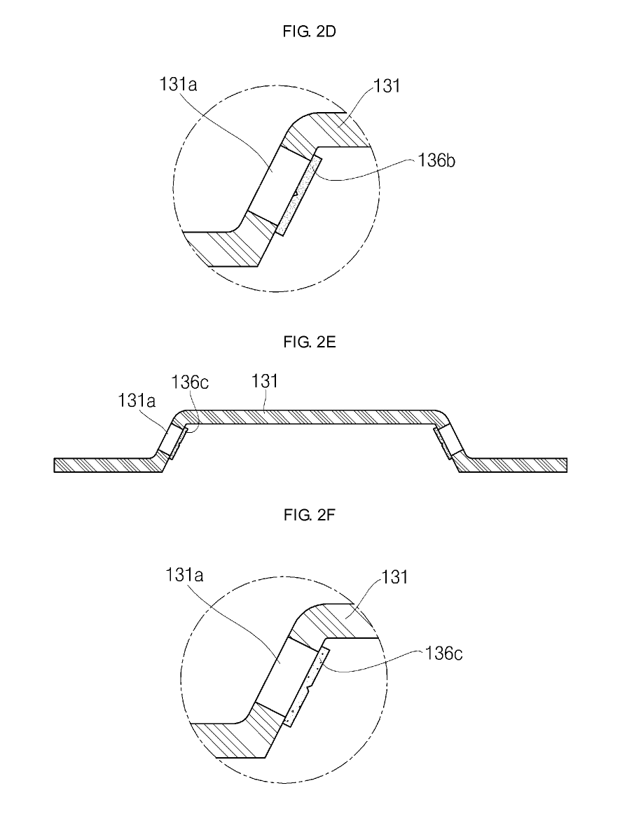

FIG. 3 is a cross-sectional view illustrating another embodiment of an indication member. Referring to FIG. 3, an indication member 236 may include a first film 236a that closes the gas release hole 131a and is adhered to an interior side of the cap 131, and a second film 236b adhered to the first film 236a. Alternatively, the indication member 236 may have a first film 236a that closes the gas release hole 231a and is adhered to an exterior side of the cap 131, and a second film 236b adhered to the first film 236a. The second film 236b may have a color different from that of the first film 236a. Alternatively, the first film 236a and the second film 236b may have the same color. Since the indication member 236 having the configuration shown in FIG. 3 closes the gas release hole 231a at normal times, only the first film 236a is externally viewed through the gas release hole 231a. However, when the gas is released through the gas release hole 231a, the indication member 236 is fractured and both the first film 236a and the second film 236b are seen from the exterior side of the cap 231, thereby clearly indicating the gas release.

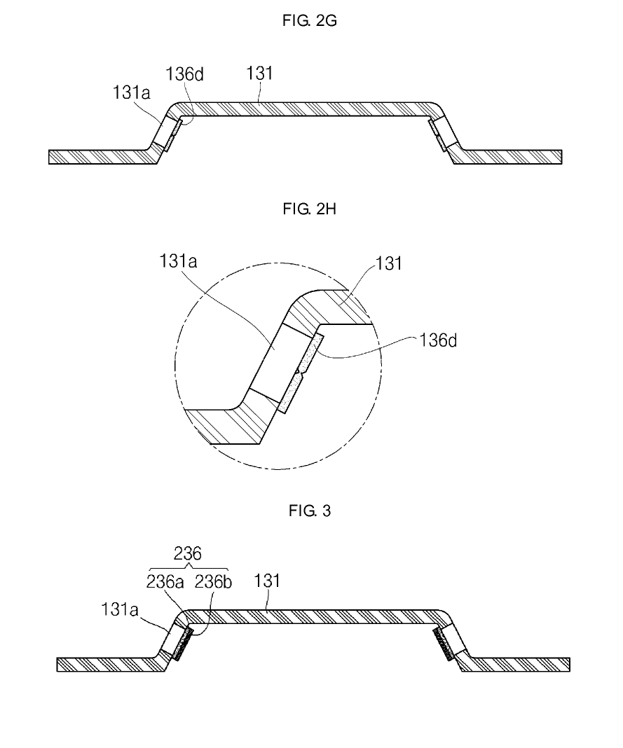

FIG. 4 is a cross-sectional view illustrating still another embodiment of an indication member. Referring to FIG. 4, an indication member 336 may include a first film 336a that closes the gas release hole 331a and is adhered to an interior side of the cap 331, a second film 336b adhered to the first film 336a, and a dye 336c disposed in a space between the first film 336a and the second film 336b. The indication member 336 having the configuration as shown in FIG. 4 closes the gas release hole 331a at normal times. However, when gas is released, the first film 336a and the second film 336b are fractured and the dye 336c disposed the space between the first film 336a and the second film 336b is dispersed around the gas release hole 331a to render a predetermined color, by which gas release can be easily identified. Here, the predetermined color rendered by the dye 336c may be different from that of the first film 336a. Alternatively, the first film 336a and the dye 336c may have the same color.

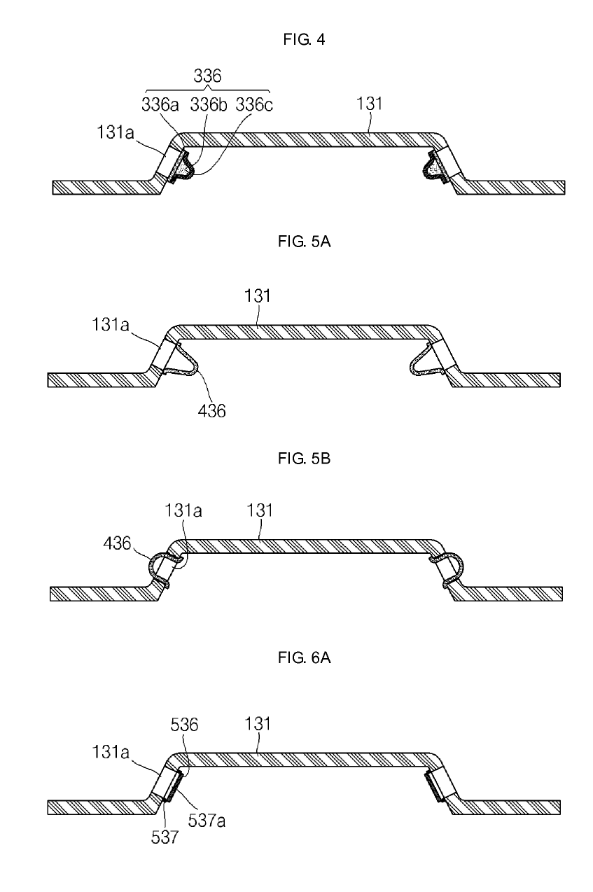

FIGS. 5A and 5B are cross-sectional views illustrating another embodiment of an indication member. Referring to FIGS. 5A and 5B, an indication member 436 closes the gas release hole 131a and is adhered to an interior side of a cap 131. The indication member 436 is positioned inside the gas release hole 131a at normal times as shown in FIG. 5A. However, when gas is released in the secondary battery sufficient to disable the secondary battery, the indication member 436 protrudes outside the gas release hole 131a, thereby clearly indicating the gas release.

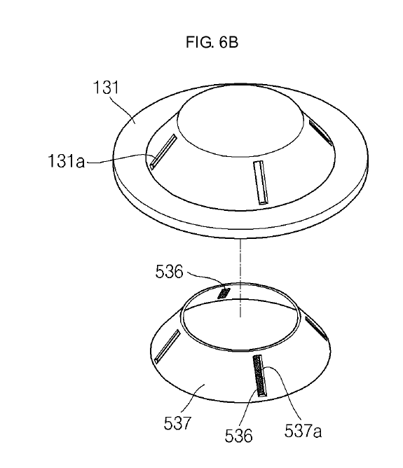

FIGS. 6A and 6B are cross-sectional views illustrating still another embodiment of an indication member. Referring to FIGS. 6A and 6B, an auxiliary plate 537 may be provided between an indication member 536 and a cap 531. The auxiliary plate 537 is coupled to an interior side of the cap 131 and has a hole 537a formed at a position corresponding to a gas release hole 131a formed in the cap 131 so as to communicate with each other or to be aligned. The hole 537a may have a size greater than or equal to the gas release hole 531a. The auxiliary plate 537 is smaller than the cap 131 so as to be closely adhered to the interior side of the cap 131 and is shaped as a funnel having a lower end circumference larger than an upper end circumference, i.e., the circumference of an end of the auxiliary plate 537 disposed closer to the can 120 is greater than the circumference of an end of the auxiliary plate 537 disposed away from the can 120. The indication member 536 is adhered to the interior side of the auxiliary plate 537. However, aspects are not limited thereto such that the indication member may be adhered to the exterior side of the auxiliary plate 537.

The indication member 536 having the configuration shown in FIGS. 6A and 6B closes the hole 537a communicating with the gas release hole 531a at normal times. However, when the gas is released through the gas release hole 131a, the indication member 536 is fractured or protrudes outside the gas release hole 131a, thereby clearly indicating from the outside of the battery whether the gas is released. The use of the auxiliary plate 537 may simplify the battery manufacturing process by coupling the auxiliary plate 537 having the indication member 536 to the cap 131 without directly forming the indication member 536 on the cap 131. In addition, the auxiliary plate 537 may be coupled to the cap 131 by thermal fusion, welding or forced fitting.

Referring back to FIG. 1, the gasket 140 is disposed at an upper end open of the can 120. In detail, the gasket 140 is closely adhered between the outer circumference of the cap 131 and safety vent 132 and the upper end open of the can 120. The gasket 140 prevents the cap assembly 130 from being separated from the can 120.

As described above, in the secondary battery 100 according to embodiments of the present invention, it is possible to easily identify whether the gas is released by forming the indication member according to aspects of the invention inside the cap 131.

In addition, in the secondary battery 100 according to embodiments of the present invention, external moisture and foreign materials can be prevented from being introduced into the battery through the gas release hole 131a as the indication member according to aspects of the invention formed in the cap 131 closes the gas release hole 131a.

Although a few embodiments of the invention have been shown and described, it would be appreciated by those skilled in the art that changes may be made in this embodiment without departing from the principles and spirit of the invention, the scope of which is defined in the claims and their equivalents.

What is claimed is:

1. A secondary battery comprising:
an electrode assembly;
a can in which the electrode assembly is disposed;
a cap disposed at an upper portion of the can and having at least one gas release hole; and
an indication member adhered to an interior side of the cap that indicates whether gas is released through the at least one gas release hole.

2. The secondary battery of claim 1, wherein the indication member is formed as a film that closes the at least one gas release hole.

3. The secondary battery of claim 2, wherein the indication member has a fracture recess formed in a surface thereof facing the at least one gas release hole.

4. The secondary battery of claim 2, wherein the indication member has a fracture recess formed in a surface thereof facing away from the at least one gas release hole.

5. The secondary battery of claim 2, wherein the indication member has fracture recesses formed both in a surface thereof facing and in a surface thereof facing away from the at least one gas release hole, respectively.

6. The secondary battery of claim 1, wherein the indication member includes a first film that closes the at least one gas release hole and adhered to the interior side of the cap, and a second film adhered to the first film.

7. The secondary battery of claim 6, wherein the second film has a color different from a color of the first film.

8. The secondary battery of claim 1, wherein the indication member includes a first film that closes the at least one gas release hole and is adhered to the interior side of the cap, a second film adhered to the first film, and a dye disposed in a space between the first and second films.

9. The secondary battery of claim 8, wherein the dye has a color different from that of the first film.

10. The secondary battery of claim 1, further comprising an auxiliary plate disposed between the cap and the indication member.

11. The secondary battery of claim 10, wherein the auxiliary plate is shaped as a funnel having a lower end circumference larger than an upper end circumference and is coupled to the cap, while attaching the internal surface of the cap.

12. The secondary battery of claim 10, wherein the auxiliary plate has at least one hole formed therethrough at a position corresponding to the at least one gas release hole formed in the cap so as to communicate with each other.

13. The secondary battery of claim 10, wherein the auxiliary plate is coupled to the interior side of the cap by thermal fusion, welding, or forced fitting.

14. The secondary battery of claim 1, wherein the indication member is fractured when the gas is released through the gas release hole.

15. The secondary battery of claim 1, wherein the indication member protrudes outside the gas release hole when the gas is released through the gas release hole.

16. The secondary battery of claim 1, further comprising a safety vent formed at a lower portion of the cap to interrupt a current and release the gas when an abnormal internal pressure occurs inside the can, wherein the indication member is fractured when the gas is released through the gas release hole.

17. The secondary battery of claim 1, further comprising a safety vent formed at a lower portion of the cap to interrupt a current and release the gas when an abnormal internal pressure occurs inside the can, wherein the indication member protrudes outside the gas release hole due to the abnormal internal pressure.

18. The secondary battery of claim 1, wherein the indication member is made of a metal or polymer.

19. The secondary battery of claim 1, wherein the indication member is adhered to the interior side of the cap by thermal fusion or welding.

20. The secondary battery of claim 1, wherein the indication member is adhered to an exterior side of the cap.
